(19) United States
(12) Patent Application Publication
(10) Pub. No.: US 2007/0049511 A1
(43) Pub. Date: Mar. 1, 2007

(54) LAUNDRY DETERGENT WITH ODOR CONTROL

(75) Inventors: Jessica Lawshe, Chandler, AZ (US); Thorsten Bastigkeit, Scottsdale, AZ (US); Ronnie Casey, New River, AZ (US); Michael Mathiesen, Scottsdale, AZ (US)

Correspondence Address: SNELL & WILMER, LLP, ONE ARIZONA CENTER, 400 E. VAN BUREN, PHOENIZ, AZ, 85004-2202, US

(73) Assignee: THE DIAL CORPORATION, Scottsdale, AZ (US)

(21) Appl. No.: 11/466,377

(22) Filed: Aug. 22, 2006

Related U.S. Application Data
(60) Provisional application No. 60/596,002, filed on Aug. 23, 2005.

(51) Int. Cl. C11D 17/00

(52) U.S. Cl. 510/424

(57) ABSTRACT

A laundry detergent for neutralizing malodors comprising a liquid detergent a non-ionic surfactant from about 1% to about 10% by weight of the composition, an an-ionic surfactant from about 1% to about 15% by weight of the composition, a metallic salt comprising zinc ricinoleate from about 0.01% to about 3% by weight of the composition, and the composition having a pH level from about 6.5 to about 9.

### FIELD OF INVENTION

The present invention relates to laundry detergent compositions which can neutralize odors on fabric while the fabric is being worn as well as removing existing odors on such fabrics while being laundered.

### BACKGROUND

It is widely known that malodors (i.e., undesirable odors) can be controlled and in some instances eliminated by utilizing a deodorizing method, a masking process, an absorption process, an ozone deodorizing process, or a catalytic process which uses a catalytic material such as a metal oxide or enzyme.

Masking processes control malodors by vaporizing and dispersing an aromatic liquid or solid such as a perfume into the ambient containing the malodor. Thus masking processes modify the malodor to a more pleasant character by superimposing a dominant, but more pleasant ordorant into the ambient. One problem with conventional aromatic liquids and solids is that such compounds tend to evaporate over an extended period of time which may result in the return of the malodor.

Absorption processes control malodors by employing an absorbent such as activated carbon or the like which absorbs odor components from the ambient. Thus, in this process, the level of intensity of the malodor is constantly being reduced from the ambient and thereby refreshing the ambient.

The ozone deodorizing process serves to decompose odor components with ozone and in catalytic processes the odor components are modified in some fashion by the catalyst being used. In typical catalytic processes, enzymes are employed as the deodorizers.

In many home care applications, malodor control and/or elimination is achieved mainly by using either a masking process or an absorption process since ozone and catalytic processes are generally not feasible.

Some commonly employed odor absorbents employed in home care applications are formulations that are based on bleach oxidizing agents, peroxides, bactericides which kill microorganisms, cyclodextrins, and/or zinc ricinoleate. Such compounds tend to form strong bonds with malodor molecules containing sulfur and nitrogen atoms.

That said, heretofore, such compositions were not without limitations. For example, in order for compositions such as zinc ricinoleate molecules to form bonds with malodor molecules, the zinc atoms need to be activated so as to expose their action sites; a non-trivial matter. For example, U.S. Pat. No. 6,528,047 relates to a water soluble odor controlling concentrate that is based on zinc ricinoleate and at least one alkoxylated amine such as C2-C4 alkoxylated coco or tallow amines that contain 2-10 moles of AO groups (AO is a C₂-C₆ alkoxylate).

Accordingly, laundry detergents with malodor neutralizing agents are desirable.

### SUMMARY OF THE INVENTION

The present invention provides a liquid laundry detergent capable of not only removing malodor from laundered items but can neutralize the odor on fabric while the fabric is being used or worn. For example, a laundry detergent in accordance with the present invention, utilizes a malodor neutralizing agent, such as a metallic salt (e.g., zinc ricinoleate), in an aqueous laundry detergent product and is very effective in controlling malodor.

In one exemplary embodiment, zinc ricinoleate is the malodor neutralizing agent. Pure zinc ricinoleate is a waxy solid that is substantially insoluble in water. Although it is difficult to solubilize the zinc ricinoleate in water, under the proper conditions, a liquid detergent composition including a nonionic surfactant and an anionic surfactant and a pH neutralizing and stabilizing ingredient provides a liquid product which is not only of good detergency but is stable and effectively controls malodor.

For example, a liquid detergent composition in accordance with an embodiment of the present invention comprises from about 0.01% to about 3% by weight of zinc ricinoleate, about 1.0% to about 10% by weight of a nonionic surfactant, about 1% to about 15% by weight of an anionic surfactant and a pH of from about 6.5 to about 9, is a very effective product.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims. Additionally, though described herein in terms of a liquid laundry detergent, other cleansing and treating materials, such as fabric softeners, stain treaters, dryer sheets or the like, may likewise fall within the ambit of the present invention.

That said, the present invention relates to an aqueous laundry detergent which is an effective detergent for cleaning fabric, is stable, and importantly, comprises a malodor neutralizing agent, effective in controlling malodor, by use during laundering and is effective at neutralizing odor on fabric when the fabric is used or worn.

In accordance with various embodiments of the present invention, the laundry detergent comprises a surfactant. In this regard, a variety of anionic and nonionic surfactants may be utilized. For example, useful anionic synthetic surfactants include linear alkyl sulfonates, fatty alkylethoxy sulfates, methyl ester sulfates, fatty alcohol sulfates and sodium lauryl ether sulfates. The anionic surfactant in accordance with a preferred embodiment is at a level from about 1.0% to about 15.0% by weight of the laundry detergent, preferably about 2% to about 10% and most preferably at a level of about 4%.

Useful nonionic surfactants include: ethoxylated nonionic surfactant such as C12-C₁₋₈ alcohol ethoxylates with 5-9 ethoxy groups. Preferred is an alcohol ethoxylate with from 14-15 carbon atoms and 7 ethoxy groups. Another useful nonionic is alkyl polyglucoside and nonyl phenol ethoxylate. Such nonionic surfactants are present from about 1.0% to about 10.0% by weight of the composition, preferably from about 2.0% to about 4.0% by weight of the composition and most preferably at about 2.0% to about 3.0%.

As noted above, in accordance with various embodiments of the present invention, the liquid detergent comprises a malodor neutralizing agent. The malodor neutralizing agent comprises any agent that is capable of reducing the level of undesirable malodors available for human perception or that is capable of otherwise decreasing the level to which malodors are perceived.

In this regard, a variety of mechanisms exist by which a malodor neutralizing agent may reduce perceptible malodors, such as, for example, chemically reacting with malodor molecules, complexing with malodor molecules, absorbing malodor molecules, encapsulating malodor molecules, and/or influencing the ability of human sensory receptors to perceive malodors (e.g., anosmia).

For example, malodor neutralizing agents suitable for use in accordance with an exemplary embodiment of the invention may combat malodors by chemically reacting or complexing with malodor molecules, by blocking human sensory reception sites that detect the presence of malodor, or by otherwise treating, blending, reacting, or counteracting malodors without increasing the perceived overall odor level in a particular environment.

In accordance with one aspect of an exemplary embodiment of the invention, metallic salts can be used effectively as malodor neutralizing agents. For example, malodor neutralizing agent may comprise a metallic salt, preferably a water-soluble zinc salt. Preferably, the metallic salt is at least one of zinc ricinoleate, zinc chloride, zinc gluconate, zinc lactate, zinc maleate, zinc salicylate, zinc sulfate, and mixtures thereof. Most preferably, the metallic salt is zinc ricinoleate.

Zinc ricinoleate controls malodors selectively through a chemical binding of low molecular weight organic compounds containing the osmogene functional groups. On the other hand, zinc ricinoleate generally has no effect on carbonylic groups, such as aldehydes and ketones, which comprise typical perfume and fragrance components.

Beneficially, zinc ricinoleate may stably complex with malodor molecules. The mode by which zinc ricinoleate complexes with malodors is similar to and can be compared to the iron binding and transport of oxygen in hemoglobin—the zinc acts as a catalyst to bind the malodor molecules, complexing it with the fatty acid side chains of the zinc ricinoleate molecule. In this way, the zinc ricinoleate neutralizes the malodors—that is, it reduces the level of undesirable malodors available for human perception.

Preferably, in accordance with the present invention, zinc ricinoleate molecules complex with one or more malodor molecules, depending on the size and shape of the malodor molecule(s). Once the complex is formed, it is a stable complex, that is, the malodor molecule will not be released from the zinc ricinoleate, even when the substrate dries.

Referring now to an exemplary embodiment of a liquid laundry detergent noted above, the malodor neutralizing agent is zinc ricinoleate, for example such as that commercially available under the trade name TegoSorb from Degussa Goldschmidt Chemical Corporation in Hopewell, Va., USA. In this embodiment, the zinc ricinoleate is used at a level of about 0.01% to about 3.0% by weight, preferably at a level of about 0.2% to about 1.0% and most preferably about 0.5% by weight.

However, some materials, such as pure zinc ricinoleate, are waxy solids and substantially insoluble in water and the solubilization of zinc ricinoleate is not an easy task. That said, once in solution the reaction sites on the zinc atoms are available to form bonds with nitrogen and sulfur atoms thereby bonding with the malodor.

As noted, the incorporation of the zinc ricinoleate into an aqueous product presents considerable difficulties. The activation of zinc ricinoleate is typically carried out by solubilizing the compound in water. However, zinc ricinoleate is insoluble in water. In fact, experiments have shown that when the zinc ricinoleate was formulated into an aqueous surfactant (laundry detergent), the zinc ricinoleate would precipitate out of the formula. Further testing showed that this unwanted precipitation occurred at a pH which is normal to an aqueous laundry detergent, that is at a pH above 8.2.

However, in accordance with an important aspect of the present invention, in order to provide a stable aqueous laundry detergent, the pH should be adjusted to a range of between about 6.5 to about 9, preferably from about 7.5 to 7.8 and most preferably to a pH of 7.8. Although adjusting the pH is very important, it has been found that it is difficult to hold the pH at a desired level. Thus, it is important to not only lower the pH but to stabilize the pH in the above noted ranges so that the ultimate product is stable and no precipitation of this zinc ricinoleate takes place for a lengthy period.

Thus, in accordance with exemplary embodiments of the present invention, laundry detergent comprises a buffering agent to bring the pH to an appropriate level and also to stabilize the product. For example, surprisingly, the addition of borax (Na₂B₄0₇-10H₂O) can be used to bring the pH to the levels described above and also to stabilize the product by serving as a buffering agent. The amount of borax used to stabilize the laundry product is from about 0.01% to about 11.0% by weight of the composition, preferably about 0.25 to about 1.75% by weight and most preferably about 0.50%. Other buffering agents that may be useful include: sodium carbonate, sodium bicarbonate and sodium sesquicarbonate.

Additional Additives

In other exemplary embodiments of the present invention, the composition may further comprise one or more other conventional additives such as a cationic and amphoteric surfactants, an optical brightener, a coloring agent, a fragrance, an enzyme, a builder, an electrolyte, a UV absorber, a bleach, a chelating agent, a preservative, a redeposition inhibitor, a dye transfer inhibitor, a thickener, a crease control agent, a pearl luster agent, a fabric softener, and/or mixtures thereof. One or more of such additives may be present in any amount suitable to achieve a particular objective. In a preferred embodiment of the invention, these additives, alone or combined, are not present in an amount that is greater than about 12% by weight of the composition. More preferably, these additives, alone or combined, are present in an amount that is less than about 8-9% by weight of the composition. However, any effective amount of additional additives, alone or combined may be utilized in accordance with the present invention insofar as such additives do not detrimentally affect the desired properties of the detergent composition.

Cationic Surfactants

In another embodiment, cationic surfactants may be added to the detergent composition. Cationic surfactants are any agent that functions as detergency booster. If cationic surfactants are used, they are present in the detergents in small quantities of preferably on the order of about 0.01 to about 10% by weight, and more preferably in quantities of about 0.1 to about 3.0% by weight.

Amphoteric Surfactants

Optionally, the detergent composition of the present invention may additionally comprise amphoteric surfactants. Amphoteric surfactants may be present in an amount of from about 0.5% to about 5% by weight of the composition.

Preferred amphoteric surfactants are the alkylbetaines of the formula (Ia), the alkylamidobetaines of the formula (Ib), the sulfobetaines of the formula (Ic) and the amidosulfobetaines of the formula (Id),
R1-N+(CH3)2-CH2COO— (Ia)
R1-CO—NH—(CH2)3-N+(CH3)2-CH2COO— (Ib)
R1-N+(CH3)2-CH2CH(OH)CH2SO3- (Ic)
R1-CO—NH—(CH2)3-N+(CH3)2-CH2CH(OH)CH2SO3- (Id)

in which R1 is a saturated or unsaturated C6-22-alkyl radical, preferably C8-18-alkyl radical, in particular a saturated C10-16-alkyl radical, for example a saturated C12-14-alkyl radical,

Particularly preferred amphoteric surfactants are the carbobetaines, in particular the carbobetaines of the formula (Ia) and (Ib), most preferably the alkylamidobetaines of the formula (Ib).

Examples of suitable betaines and sulfobetaines are the following compounds named according to INCI: Almondamidopropyl Betaine, Apricotamidopropyl Betaine, Avocadamidopropyl Betaine, Babassuamidopropyl Betaine, Behenamidopropyl Betaine, Behenyl Betaine, Betaine, Canolamidopropyl Betaine, Capryl/Capramidopropyl Betaine, Carnitine, Cetyl Betaine, Cocamidoethyl Betaine, Cocamidopropyl Betaine, Cocamidopropyl Hydroxysultaine, Coco-Betaine, Coco-Hydroxysultaine, Coco/Oleamidopropyl Betaine, Coco-Sultaine, Decyl Betaine, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl PG-Betaine, Erucamidopropyl Hydroxysultaine, Hydrogenated Tallow Betaine, Isostearamidopropyl Betaine, Lauramidopropyl Betaine, Lauryl Betaine, Lauryl Hydroxysultaine, Lauryl Sultaine, Milkamidopropyl Betaine, Minkamidopropyl Betaine, Myristamidopropyl Betaine, Myristyl Betaine, Oleamidopropyl Betaine, Oleamidopropyl Hydroxysultaine, Oleyl Betaine, Olivamidopropyl Betaine, Palmamidopropyl Betaine, Palmitamidopropyl Betaine, Palmitoyl Carnitine, Palm Kernelamiodopropyl Betaine, Polytetrafluoroethylene Acetoxypropyl Betaine, Ricinoleamidopropyl Betaine, Sesamidopropyl Betaine, Soyamidopropyl Betaine, Stearamidopropyl Betaine, Stearyl Betaine, Tallowamidopropyl Betaine, Tallowamidopropyl Hydroxysultaine, Tallow Betaine, Tallow Dihydroxyethyl Betaine, Undecylenamidopropyl Betaine and Wheat Germamidopropyl Betaine. Other suitable amphoteric surfactants may also be employed.

Optical Brighteners

In one aspect of an exemplary embodiment of the invention, an optical brightener (so-called “whitening agents”) component, may be present in an amount from about 0.01 to about 1% by weight, based on the finished product. The optical brightener agent can comprise virtually any brightener that is capable of eliminating graying and yellowing of fabrics. Typically, these substances attach to the fibers and bring about a brightening and simulated bleaching action by converting invisible ultraviolet radiation into visible longer-wave length light, the ultraviolet light absorbed from sunlight being irradiated as a pale bluish fluorescence and, together with the yellow shade of the grayed or yellowed laundry, producing pure white.

In one embodiment, the preferred optical brightener is 0.06% by weight of Tinopal UNPA, which is commercially available through the Ciba Geigy Corporation located in Switzerland.

Additional optical brighteners useful in accordance with a preferred embodiment of the present invention include, but are not limited to, the classes of substance of 4,4′-diamino-2,2′-stilbenedisulfonic acids (flavonic acids), 4,4′-distyrylbiphenyls, methylumbelliferones, coumarins, dihydroquinolinones, 1,3-diarylpyrazolines, naphthalimides, benzoxazol, benzisoxazol and benzimidazol systems, and pyrene derivatives substituted by heterocycles, and the like.

Coloring Agents

In accordance with another aspect of an exemplary embodiment of the invention, coloring agents and dyes, especially bluing agents, may be added to increase aesthetic appeal and consumer performance impression of the composition. When present, such coloring agents and/or dyes are preferably used at very low levels such as from about 0.0001 to 0.001% by weight of the composition, to avoid staining or marking surfaces on which the compositions may be used, such as fabrics.

In accordance with a preferred aspect of an exemplary embodiment of the invention, the composition comprises Liquitint Blue HP, available from Milliken Chemical Company.

However, a wide variety of coloring agents and dyes suitable for use in accordance with the present invention are well known to those skilled in the art. Other non-limiting examples of suitable dyes are, Liquitint Blue HP®, Liquitint Blue 65®, Liquitint Patent Blue®, Liquitint Royal Blue®, Liquitint Experimental Yellow 8949-43®, Liquitint Green HMC®, Liquitint Yellow II®, and mixtures thereof, preferably Liquitint Blue HP®, Liquitint Blue 65®, Liquitint Patent Blue®, Liquitint Royal Blue®, Liquitint Experimental Yellow 8949-43®, and mixtures thereof.

Fragrances

In another aspect of an exemplary embodiment of the invention, a fragrance component may be present in an amount of from about 0.01 to about 0.5% by weight. The fragrance component may comprise any agent that is capable of covering the chemical odor of the composition and the odor of soils in the washing solution, imparting a pleasant scent to fabrics, and/or contributing an identifying scent to the product. Additionally, a variety of fragrance components are available that employ any number of malodor-neutralizing mechanisms in addition to malodor covering agents are suitable for use in connection with the various embodiments of the present invention.

Fragrance components useful in the present invention are known in the art and are available from any number of sources. For example, in accordance with a preferred aspect of an exemplary embodiment of the invention, the composition comprises a Mountain Breeze scent, which is commercially available from the Lebermuth Company located in South Bend, Ind. However, it will be appreciated that any known or hereafter devised scent, such as for example, baby powder or lemon may be used in accordance with the present invention.

For example, the fragrance component may comprise the synthetic products of the ester, ether, aldehyde, ketone, alcohol and hydrocarbon types. Preference, however, is given to using mixtures of different odorants, which together produce an appealing fragrance note. Such perfume oils may also contain natural odorant mixtures, as are obtainable from plant sources.

Enzymes

The present invention's laundry detergent compositions may also comprise enzymes. The enzyme may comprise any agent which aids in breaking down complex soils, especially proteins such as grass and blood, so that these soils can be more easily removed by other detergent ingredients. Enzymes may be formed into shaped articles and adsorbed on carriers or embedded in coatings and thus be protected against premature decomposition. The amount of enzyme(s) may range from about 0.01% to about 5% by weight, preferably from about 0.12% to about 2.5% by weight, each percentage being based on the entire composition.

Useful enzymes include, but are not limited to, the class of the hydrolases such as the proteases, esterases, lipases or lipolytically acting enzymes, amylases, cellulases or other glycosyl hydrolases, hemicellulases, cutinases, β-glucanases, oxidases, peroxidases, perhydrolases or laccases and mixtures thereof. All these hydrolases contribute in the wash to the removal of stains such as proteinaceous, greasy or starchy stains and grayness. Cellulases and other glycosyl hydrolases may in addition, through the removal of pilling and microfibrils, contribute to textile color preservation and softness enhancement. Similarly, oxyreductases can be used for bleaching or for inhibiting dye transfer. Enzymatic actives obtained from bacterial strains or fungi such as Bacillus subtilis, Bacillus licheniformis, Streptomyceus griseus and Humicola insolens are particularly useful. Preference is given to proteases of the subtilisin type and especially proteases obtained from Bacillus lentus. Enzyme mixtures, for example of protease and amylase or of protease and lipase or lipolytically acting enzymes or of protease and cellulase or of cellulase and lipase or lipolytically acting enzymes or of protease, amylase and lipase or of lipolytically acting enzymes or protease, lipase or lipolytically acting enzymes and cellulase, but especially protease and/or lipase-containing mixtures or mixtures with lipolytically acting enzymes are of particular interest. The familiar cutinases are examples of such lipolytically acting enzymes. Similarly, peroxidases or oxidases will be found useful in some cases. Useful amylases include especially α-amylases, isoamylases, pullulanases and pectinases. Cellulases used are preferably cellobiohydrolases, endoglucanases and β-glucosidases, also known as cellobiases, and mixtures thereof. Since the various cellulase types differ in CMCase and Avicelase activity, desired activities can be achieved through specific mixtures of the cellulases.

Builders

Optionally, the composition of the present invention may comprise builders. As is known in the art, water hardness ions may interact with negatively charged surfactants and inhibit soil removal and decreasing the overall efficiency of the surfactant system. As such, it may be desirable to include a builder to soften water by tying up water hardness, prevents redeposition of soils, and provides a desirable level of alkalinity, which aids in cleaning. The compositions of the present invention may, if appropriate, comprise builders in amounts of from about 1% to about 30% by weight, preferably about 2 to about 15%, and more preferably about 2 to about 5%.

Any builder customarily used in washing and cleaning compositions may be incorporated in the compositions of the present invention, including especially zeolites, silicates, carbonates, organic cobuilders and where there are no ecological prejudices against their use, phosphates.

In one embodiment of the present invention, a precipitating builder, such as sodium carbonate or sodium silicate is used to remove water hardness ions by forming an insoluble substance or precipitant. Addition of a builder such as sodium carbonate is especially preferable when the water hardness is due to calcium ions.

Useful crystalline, sheet-shaped sodium silicates have the general formula NaMSixO2x+1.H2O, where M is sodium or hydrogen, x is from 1.9 to 4, y is from 0 to 20 and x is preferably 2, 3 or 4. Such crystalline sheet silicates. Preferred crystalline sheet silicates of the stated formula are those in which M is sodium and x is 2 or 3. In particular, not only β- but also δ-sodium disilicates Na2Si2O5.yH₂O are preferred.

The finely crystalline synthetic zeolite used, containing bound water, is preferably zeolite A and/or P. Zeolite P is particularly preferably Zeolite MAP® (commercial product from Crosfield). Also suitable, however, are zeolite X, and mixtures of A, X and/or P. A co-crystallizate of zeolite X and zeolite A (about 80% by weight of zeolite X), which is sold by CONDEA Augusta S.p.A. under the trade name VEGOBOND AX® Useful zeolites have an average particle size of less than 10 μm (volume distribution; method of measurement: Coulter Counter) and have a bound-water content which is preferably in the range from about 18% to about 22% by weight and especially in the range from about 20% to about 22% by weight. The zeolites can also be used as over-dried zeolites having lower water contents and then are by virtue of their hygroscopicity useful to remove unwanted trace residues of free water.

It will be appreciated that the well-known phosphates can likewise be used as builder substances, unless such a use is to be avoided for ecological reasons. Useful phosphates include in particular the sodium salts of the orthophosphates, of the pyrophosphates and especially of the tripolyphosphates.

Organic builder substances useful as cobuilders and also as viscosity regulators include for example the polycarboxylic acids which can be used in the form of their sodium salts, polycarboxylic acids referring to carboxylic acids having more than one acid function. Examples thereof are citric acid, adipic acid, succinic acid, glutaric acid, malic acid, tartaric acid, maleic acid, fumaric acid, sugar acids, amino carboxylic acids, nitrilotriacetic acid (NTA) and derivatives thereof and also mixtures of these. Preferred salts are the salts of polycarboxylic acids such as citric acid, adipic acid, succinic acid, glutaric acid, tartaric acid, sugar acids and mixtures of these.

The acids themselves can be used as well. As well as their builder action, the acids typically also have the property of an acidifying component and thus also serve to impart a lower and milder pH to washing or cleaning compositions. Particularly used for this are citric acid, succinic acid, glutaric acid, adipic acid, gluconic acid and any desired mixtures of these. Useful acidifying agents further include known pH regulators such as sodium bicarbonate and sodium hydrogensulfate.

Useful builders further include polymeric poly carboxylates, i.e., for example the alkali metal salts of polyacrylic acid or of polymethacrylic acid, for example those having a relative molecular mass in the range from 500 to 70,000 g/mol.

Useful polymers are in particular polyacrylates which preferably have a molecular mass in the range from about 2000 to about 20,000 g/mol. Owing to their superior solubility, preference in this group may be given in turn to the short-chain polyacrylates which have molar masses in the range from 2000 to 10,000 g/mol and more preferably in the range from 3000 to 5000 g/mol.

Useful polymers may further include substances which partly or wholly consist of units of vinyl alcohol or its derivatives.

Useful polymeric polycarboxylates further include copolymeric polycarboxylates, especially those of acrylic acid with methacrylic acid and of acrylic acid or methacrylic acid with maleic acid. Of particular usefulness are copolymers of acrylic acid with maleic acid which comprise from about 50% to about 90% by weight of acrylic acid and from about 10% to about 50% by weight of maleic acid. Their relative molecular mass based on free acids is generally in the range from 2000 to 70,000 g/mol, preferably in the range from 20,000 to 50,000 g/mol and especially in the range from 30,000 to 40,000 g/mol. (Co)polymeric polycarboxylates can be used either as an aqueuous solution or preferably as a powder.

To improve solubility in water, polymers may further comprise allylsulfonic acids, such as allyloxybenzenesulfonic acid and methallylsulfonic acid, as a monomer.

Preference is also given in particular to biodegradable polymers composed of more than two different monomer units, for example those which comprise salts of acrylic acid and of maleic acid and also vinyl alcohol or vinyl alcohol derivatives as monomers or comprise salts of acrylic acid and of 2-alkylallylsulfonic acid and also sugar derivatives as monomers.

Preferred copolymers further include those which as monomers preferably comprise acrolein and acrylic acid/acrylic acid salts or acrolein and vinyl acetate.

Preferred builder substances further include polymeric amino dicarboxylic acids, their salts or their precursor substances. Particular preference is given to polyaspartic acids or salts and derivatives thereof, of which it is known that they have a bleach-stabilizing effect as well as cobuilder properties. It is further possible to use polyvinylpyrrolidones, polyamine derivatives such as quaternized and/or ethoxylated hexamethylenediamines.

Useful builder substances further include polyacetals which can be obtained by reacting dialdehydes with polycarboxylic acids having 5 to 7 carbon atoms and 3 or more hydroxyl groups. Preferred polyacetals are obtained from dialdehydes such as glyoxal, glutaraldehyde, terephthalaldehyde and mixtures thereof and from polycarboxylic acids such as gluconic acid and/or glucoheptonic acid.

Useful organic builder substances further include dextrins, for example oligomers or polymers of carbohydrates obtainable by partial hydrolysis of starches. The hydrolysis can be carried out by customary, for example acid- or enzyme-catalyzed, processes. The hydrolysis products preferably have average molar masses in the range from 400 to 500,000 g/mol. Preference here is given to a polysaccharide having a dextrose equivalent (DE) in the range from 0.5 to 40 and especially from 2 to 30, DE being a common measure of the reducing effect of a polysaccharide compared with dextrose, which has a DE of 100. It is also possible to use maltodextrins having a DE between 3 and 10 and dried glucose syrups having a DE between 20 and 37, and also so-called yellow dextrins and white dextrins having relatively higher molar masses in the range from 2000 to 30,000 g/mol.

The oxidized derivatives of such dextrins are their reaction products with oxidizing agents which are able to oxidize at least one alcohol function of the saccharide ring to the carboxylic acid function. It is likewise possible to use an oxidized oligosaccharide. A product oxidized on the C6 of the saccharide ring may be particularly advantageous.

Useful cobuilders further include oxydisuccinates and other derivatives of disuccinates, preferably ethylenediaminedisuccinate. Here, ethylenediamine-N,N′-disuccinate (EDDS), is used in the form of its sodium or magnesium salts. Also preferable in this connection are glycerol disuccinates and glycerol trisuccinates. Suitable use levels in zeolite-containing and/or silicate-containing formulations range from 3% to 15% by weight.

Useful organic cobuilders further include for example acetylated hydroxycarboxylic acids and salts thereof, which may if desired also be present in lactone form and which comprise at least 4 carbon atoms and at least one hydroxyl group and also not more than two acid groups.

Electrolytes

Optionally, the compositions of the present invention may comprise electrolytes. A large number of various salts can be used as electrolytes from the group of the inorganic salts. Preferred cations are the alkali and alkaline earth metals and preferred anions are the halides and sulfates. From the point of view of manufacturing convenience, the use of NaCl or MgCl2 in the compositions of the present invention is preferred. The amount of electrolytes in the compositions of the present invention is typically in the range from 0.5% to 5% by weight.

UV Absorbers

The compositions of the present invention may further comprise UV absorbers. UV absorbers may comprise any agent which improves the light stability of the fibers and/or the light stability of the other formula components. UV absorbers should be understood to mean organic substances (light filters) which are capable of absorbing ultraviolet rays and reemitting the absorbed energy in the form of longer-wave radiation, e.g. heat. UV absorbers are typically used in amounts ranging from about 0.01% by weight to about 5% by weight, and preferably from 0.03% by weight to 1% by weight.

Examples of compounds which have these desired properties include, but are not limited to, the compounds active through non-radiative deactivation and derivatives of benzophenone with substituents in the 2- and/or 4-position. Further, substituted benzotriazoles, such as for example the water-soluble benzenesulfonic acid-3-(2H-benzotriazol-2-yl)-4-hydroxy-5-(methylpropyl)-monosodium salt (Cibafast® H), acrylates phenyl-substituted in the 3-position (cinnamic acid derivatives), optionally with cyano groups in the 2-position, salicylates, organic Ni complexes and natural substances such as umbelliferone and the endogenous urocanic acid are suitable. Of particular importance are biphenyl derivatives and, above all, stilbene derivatives and are commercially available from Ciba as Tinosorb® FD or Tinosorb® FR.

As UV-B absorbers, mention can be made of 3-benzylidenecamphor and 3-benzylidene-norcamphor and derivatives thereof, e.g. 3-(4-methylbenzylidene)camphor, 4-aminobenzoic acid derivatives, preferably 4-(dimethylamino)benzoic acid 2-ethylhexyl ester, 4-(dimethylamino)benzoic acid 2-octyl ester and 4-(dimethylamino)benzoic acid amyl ester, esters of cinnamic acid, preferably 4-methoxycinnamic acid 2-ethylhexyl ester, 4-methoxycinnamic acid propyl ester, 4-methoxycinnamic acid isoamyl ester and 2-cyano-3,3-phenylcinnamic acid 2-ethylhexyl ester (Octocrylene), esters of salicylic acid, preferably salicylic acid 2-ethylhexyl ester, salicylic acid 4-isopropylbenzyl ester and salicylic acid homomenthyl ester, derivatives of benzophenone, preferably 2-hydroxy-4-methoxybenzophenone, 2-hydroxy-4-methoxy-4′-methylbenzophenone and 2,2′-dihydroxy-4-methoxy-benzophenone, esters of benzalmalonic acid, preferably 4-methoxybenzmalonic acid di-2-ethylhexyl ester, triazine derivatives such as for example 2,4,6-trianilino-(p-carbo-2′-ethyl-1′-hexyloxy)-1,3,5-triazine and octyl triazone, or dioctyl butamido triazone (Uvasorbg HEB), propane-1,3-diones such as for example 1-(4-tert-butylphenyl)-3-(4′-methoxyphenyl)propane-1,3-dione and ketotricyclo-(5.2.1.0)decane derivatives. Also suitable are 2-phenylbenzimidazole-5-sulfonic acid and alkali metal, alkaline earth metal, ammonium, alkylammonium, alkanolammonium and glucammonium salts thereof, sulfonic acid derivatives of benzophenones, preferably 2-hydroxy-4-methoxybenzophenone-5-sulfonic acid and salts thereof, sulfonic acid derivatives of 3-benzylidenecamphor, such as for example 4-(2-oxo-3-bomylidenemethyl)benzene-sulfonic acid and 2-methyl-5-(2-oxo-3-bornylidene)sulfonic acid and salts thereof.

Typical UV-A filters are in particular derivatives of benzoylmethane, such as for example 1-(4′-tert-butyl-phenyl)-3-(4′-methoxyphenyl)propane-1,3-dione, 4-tert-butyl-4′-methoxydibenzoylmethane (Parsol 1789), 1-phenyl-3-(4′-isopropylphenyl)-propane-1,3-dione and also enamine compounds. The UV-A and UV-B filters can of course also be used as mixtures. In addition to the stated soluble substances, insoluble light-protective pigments, that is finely dispersed preferably nanoized metal oxides or salts, are also possible for this. Examples of suitable metal oxides are in particular zinc oxide and titanium dioxide and also oxides of iron, zirconium, silicon, manganese, aluminum and cerium and also mixtures thereof. As salts, silicates (talc), barium sulfate or zinc stearate can be used. The oxides and salts are already used in the form of the pigments for skincare and skin protection emulsions and decorative cosmetics. The particles here should have a mean diameter of less than 100 nm, preferably between 5 and 50 nm and in particular between 15 and 30 nm. They can be spherical in shape, but particles having an ellipsoidal shape or a shape deviating in other ways from the spherical form can also be used. The pigments can also be surface-treated, i.e. hydrophobized or hydrophilized. Typical examples are coated titanium dioxides, such as for example titanium dioxide T 805 (Degussa) or Eusolex® T2000 (Merck). Possible hydrophobic coating agents here are above all silicones and specifically trialkoxyoctylsilanes or simethicones. Preferably, micronized zinc oxide is used.

Bleach Agent

A detergent composition of the present invention may further comprise a bleaching agent. Various bleaching agents are known in the art and include any agent which makes the fabric whiter or lighter especially by physical or chemical removal of color. The amount of bleaching agent in the compositions of the present invention is typically in the range from about 0.5% to about 10% by weight.

Among compounds which serve as bleaches in that they liberate H2O2 in water, sodium percarbonate, sodium perborate tetrahydrate, sodium perborate monohydrate. Useful bleaches further include for example peroxypyrophosphates, citrate perhydrates and also H2O2-supplying peracidic salts or peracids, such persulfates and persulfuric acid. It is also possible to use urea peroxohydrate, i.e., percarbamide, which is described by the formula H₂N—CO—NH2.H₂O₂. Especially when the compositions are used for cleaning hard surfaces, for example in dishwashers, they can if desired also include bleaches from the group of organic bleaches, although their use is in principle also possible in textile-washing compositions. Typical organic bleaches include diacyl peroxides, for example dibenzoyl peroxide. Typical organic bleaches further include peroxyacids, examples being in particular alkylperoxyacids and arylperoxy-acids. Preferred representatives are peroxybenzoic acid and its ring-substituted derivatives, such as alkylperoxybenzoic acids, but also peroxy-α-naphthoic acid and magnesium monoperphthalate, aliphatic or substitutedly aliphatic peroxyacids, such as peroxylauric acid, peroxystearic acid, ε-phthalimidoperoxycaproic acid (phthalimidoperoxyhexanoic acid, PAP), o-carboxybenzamidoperoxycaproic acid, N-nonenylamidoperadipic acid and N-nonenylamidopersuccinates, and alipahtic and araliphatic peroxydicarboxylic acids, such as 1,12-diperoxy carboxylic acid, 1,9-diperoxyazelaic acid, diperoxysebacic acid, diperoxybrassylic acid, diperoxyphthalic acids, 2-decyldiperoxybutane-1,4-diacid, N,N-terephthaloyldi(6-aminopercaproic acid). More preferably, the compositions of the present invention may comprise phthalimidoperoxyhexanoic acid (PAP).

The compositions of the present invention may further comprise bleach activators. Compounds used as bleach activators produce aliphatic peroxo carboxylic acids having preferably 1 to 10 carbon atoms and especially 2 to 4 carbon atoms and/or as the case may be substituted perbenzoic acid under perhydrolysis conditions. Substances which bear O- and/or N-acyl groups of the stated number of carbon atoms and/or substituted or unsubstituted benzoyl groups are suitable. Preference is given to multiply acylated alkylenediamines, especially tetraacetylethylenediamine (TAED), acylated triazine derivatives, especially 1,5-diacetyl-2,4-dioxohexahydro-1,3,5-tri-azine (DADHT), acylated glycolurils, especially tetraacetylglycoluril (TAGU), N-acylimides, especially N-nonanoylsuccinimide (NOSI), acylated phenolsulfonates, especially n-nonanoyl- or isononanoyloxybenzenesulfonate (n- and iso-NOBS respectively), carboxylic anhydrides, especially phthalic anhydride, acylated polyhydric alcohols, especially triacetin, triethyl acetylcitrate (TEAC), ethylene glycol diacetate, 2,5-diacetoxy-2,5-dihydrofuran and the enol esters and also acetylated sorbitol and mannitol or to be more precise their SORMAN mixtures, acylated sugar derivatives, especially pentaacetylglucose (PAG), pentaacetylfructose, tetraacetylxylose and octaacetyllactose and also acylated, optionally N-alkylated glucamine and gluconolactone, and/or N-acylated lactams, for example N-benzoylcaprolactam. The hydrophilically substituted aceylacetals and the acyllactams are likewise preferred. Similarly, the combinations of conventional bleach activators can likewise be used.

Chelating Agents

The present invention's detergent compositions may also comprise suitable chelating agents. Chelating agents may include any agents used to deactivate hard water minerals such as calcium and magnesium and to reduce the effects of other dissolved metals such as manganese.

In a preferred embodiment of the present invention, the chelating agents are present in an amount preferably from about 0.001% to about 5% by weight, more preferably from 0.001% to 1% by weight and especially from 0.001% to 0.5% by weight, each percentage being based on the entire composition.

In one embodiment, ethylenediaminetetraacetic acid (EDTA) is used as the chelating agent. Other preferred chelants according to the present invention can be selected from the group consisting of amino carboxylates, amino phosphonates, polyfunctionally-substituted aromatic chelating agents and mixtures thereof, all as hereinafter defined and all preferably in their acidic form. Amino carboxylates useful as chelating agents herein include ethylenediaminetetraacetic acid (EDTA), N-hydroxyethylethylenediaminetriacetates, nitrilotriacetates (NTA), ethylenediamine tetraproprionates, ethylenediamine-N,N′-diglutamates, 2-hydroxypropylenediamine-N,N′-disuccinates, triethylenetetraaminehexacetates, diethylenetriaminepentacetates (DTPA) and ethanoldiglycines, including their water-soluble salts such as the alkali metal, ammonium, and substituted ammonium salts thereof and mixtures thereof.

Preservative

Optionally, a solubilized preservative may be added to the composition of the present invention. Preferred levels of the preservative, when present, are from about 0.01% to about 0.5% by weight of the composition, and more preferably from about 0.02 to about 0.2% by weight of the composition, and most preferably from about 0.05% to about 0.1% by weight of the composition.

It is preferable to utilize a preservative that is effective to inhibit and/or control both bacteria and fungi. In accordance with an aspect of an exemplary embodiment of the present invention, an effective amount of Dantogard® preservative, available from Lonza Group of Switzerland, is utilized. Additional suitable preservatives may include any organic preservative that will not adversely affect or damage fabric articles. Preferred water-soluble preservatives include, for example, halogenated compounds, hydantoin compounds, organic sulfur compounds, low molecular weight aldehydes, benzalkonium chlorides, alkylaryl-sulfonates, halophenols, cyclic organic nitrogen compounds, quaternary compounds, dehydroacetic acid, phenyl and phenoxy compounds.

Redeposition Inhibitor

A redeposition inhibitor (“grayness inhibitor”) may also be added to the composition of the present invention. Typically, the amount of these redeposition inhibitors does not exceed about 2% by weight of the total formulation. Redeposition inhibitors are any agent designed to keep the soil detached from the fiber suspended in the liquor and to prevent its redeposition on the fiber.

Useful redeposition inhibitors may include water-soluble colloids mostly organic in nature, for example glue, gelatin, salts of ether sulfonic acids of starch or of cellulose or salts of acidic sulfuric esters of cellulose or of starch. Similarly, water-soluble polyamides which comprise acidic groups are suitable for this purpose. It is also possible to use soluble starch preparations and starch products other than those mentioned above, for example degraded starch, aldehyde starches, etc. Polyvinylpyrrolidone can be used as well. However, preference is given to cellulose ethers such as carboxymethylcellulose (sodium salt), methylcellulose, hydroxyalkylcellulose and mixed ethers such as methylhydroxyethylcellulose, methylhydroxypropylcellulose, methylcarboxymethylcellulose.

Suitable anti-redeposition agents, which are also referred to as soil repellants, also include, for example, nonionic cellulose ethers, such as methylcellulose and methylhydroxypropylcellulose with a content of methoxy groups of from 15 to 30% by weight and of hydroxypropyl groups of from 1 to 15% by weight, in each case based on the nonionic cellulose ethers, and the polymers, known from the prior art, of phthalic acid and/or terephthalic acid or derivatives thereof, in particular polymers of ethylene terephthalates and/or polyethylene glycol terephthalates or anionically and/or nonionically modified derivatives of these. Of these, particular preference is given to the sulfonated derivatives of phthalic acid and terephthalic acid polymers.

Dye Transfer Inhibitors

Optionally, dye transfer inhibitors may also be added to the present invention. Dye transfer inhibitors include any agent that is capable of preventing redeposition of free dyes onto textile. As a result, textiles keep their original color and whites stay white, even after multiple washes. Preferred levels of dye transfer inhibitors, when present are from about 0.01% to about 0.5% by weight of composition.

Useful dye transfer inhibitors include not only the polyvinylpyrrolidones of molecular weights in the range from about 15,000 to about 50,000, but also the polyvinylpyrrolidones having molar weights above about 1,000,000, especially from about 1,500,000 to about 4,000,000, the N-vinylimidazole-N-vinylpyrrolidone copolymers, the polyvinyloxazolidones, the copolymers based on vinyl monomers and carboxamides, the polyesters and polyamides containing pyrrolidone groups, the grafted polyamidoamines and polyethyleneimines, the polymers with amide groups from secondary amines, the polyamine N-oxide polymers, the polyvinyl alcohols, and the copolymers based on acrylamidoalkenylsulfonic acids. However, it is also possible to use enzymatic systems, comprising a peroxidase and hydrogen peroxide or a substance which in water provides hydrogen peroxide. The addition of a mediator compound for the peroxidase, for example, an acetosyringone, a phenol derivative, or a phenothiazine or phenoxazine, is preferred in this case, it being also possible to use abovementioned active polymeric dye transfer inhibitor substances as well. Polyvinylpyrrolidone for use in compositions of the invention preferably has an average molar mass in the range from 10,000 to 60,000, in particular in the range from 25,000 to 50,000. Among the copolymers, preference is given to those of vinylpyrrolidone and vinylimidazole in a molar ratio of 5:1 to 1:1 having an average molar mass in the range from 5,000 to 50,000, in particular from 10,000 to 20,000.

Thickeners (Polymers)

Furthermore, the present invention's liquid laundry detergent compositions may further comprise thickeners preferably in amounts up to about 10% by weight, more preferably up to 5% by weight and especially in the range from about 0.1% to about 1% by weight, each based on the entire composition.

The use of thickeners in the liquid laundry detergent compositions of the present invention will be particularly advantageous. The use of thickeners in particular in gel-like liquid laundry detergent compositions will boost consumer acceptance. The thickened consistency of the composition simplifies the application of the compositions directly to the stains to be treated. The kind of run-off familiar from thin liquid compositions is prevented as a result. In a preferred embodiment, the thickener comprises Acusol 430, available from Axo Chemical, Inc. Other suitable polymers include, but are not limited to, polymers originating in nature such as, agar-agar, carrageen, tragacanth, gum arabic, alginates, pectins, polyoses, guar flour, carob seed flour, starch, dextrins, gelatins and casein.

Modified natural substances originate primarily from the group of modified starches and celluloses, examples which may be mentioned here being carboxymethylcellulose and cellulose ethers, hydroxyethylcellulose and hydroxypropylcellulose, and carob flour ether.

A large group of thickeners which is used widely in very diverse fields of application are the completely synthetic polymers, such as polyacrylic and polymethacrylic compounds, vinyl polymers, polycarboxylic acids, polyethers, polyimines, polyamides and polyurethanes.

Thickeners from said classes of substance are commercially widely available and are offered, for example, under the trade names Acusol®-820 (methacrylic acid (stearyl alcohol-20-EO) ester-acrylic acid copolymer, 30% strength in water, Rohm & Haas), Polygel, such as Polygel DA (3V Sigma), Carbopol® (B.F. Goodrich), such as Carbopol 940 (molecular weight approximately 4.000.000), Carbopol 941 (molecular weight approximately. 1.250.000), Carbopol 934 (molecular weight approximately 3. 000.000), Carbopol ETD 2623, Carbopol 1382 (INCI Acrylates/C10-30 Alkyl Acrylate Crosspolymer) and Carbopol Aqua 30, Aculyn® and Acusol® (Rohm & Haas), Tego® Degussa-Goldschmidt), Dapral®-GT-282-S (alkyl polyglycol ether, Akzo), Deuterol®-Polymer-11 (dicarboxylic acid copolymer, Schöner GmbH), Deuteron®-XG (anionic heteropolysaccharide based on β-D-glucose, D-manose, D-glucuronic acid, Schöner GmbH), Deuteron®-XN (nonionogenic polysaccharide, Schöner GmbH), Dicrylan®-Verdicker-O (ethylene oxide adduct, 50% strength in water/isopropanol, Pfersse Chemie), EMA®-81 and EMA®-91 (ethylene-maleic anhydride copolymer, Monsanto), Verdicker-QR-1001 (polyurethane emulsion, 19-21% strength in water/diglycol ether, Rohm & Haas), Mirox®-AM (anionic acrylic acid-acrylic ester copolymer dispersion, 25% strength in water, Stockhausen), SER-AD-FX-1100 (hydrophobic urethane polymer, Servo Delden), Shellflo®-S (high molecular weight polysaccharide, stabilized with formaldehyde, Shell), and Shellflo®-XA (xanthan biopolymer, stabilized with formaldehyde, Shell).

A preferred polymeric polysaccharide thickener is xanthan, a microbial anionic heteropolysaccharide produced by Xanthomonas campestris and other species under aerobic conditions and has a molar mass in the range from 2 to 15 million g/mol. Xanthan is formed from a chain of β-1,4-bound glucose (cellulose) having side chains. The structure of the subgroups consists of glucose, mannose, glucuronic acid, acetate and pyruvate, the number of pyruvate units determining the viscosity of the xanthan.

Crease Control Agents

The compositions of the present invention may comprise crease control agents. Since textile fabrics, especially those composed of rayon, wool, cotton and blends thereof, may tend to crease because the individual fibers are sensitive to bending, kinking, pressing and squashing transversely to the fiber direction, the compositions may comprise synthetic anticrease agents. Suitable crease control agents include, for example, synthetic products based on fatty acids, fatty acid esters, fatty acid amides, fatty acid alkylolesters, fatty acid alkylolamides or fatty alcohols, which have mostly been reacted with ethylene oxide, or products based on lecithin or modified phosphoric esters.

Pearl Luster Agents

As well as the aforementioned components, the present invention's liquid laundry detergent compositions may comprise pearl luster agents. Pearl luster components include any agent which endow textiles with an additional luster.

Examples of useful pearl luster agents include, but are not limited to: alkylene glycol esters; fatty acid alkanolamides; partial glycerides; esters of polybasic carboxylic acids with or without hydroxyl substitution with fatty alcohols having 6 to 22 carbon atoms; fatty materials, for example fatty alcohols, fatty ketones, fatty aldehydes, fatty ethers and fatty carbonates which together have at least 24 carbon atoms; ring-opening products of olefin epoxides having 12 to 22 carbon atoms with fatty alcohols having 12 to 22 carbon atoms, fatty acids and/or polyols having 2 to 15 carbon atoms and 2 to 10 hydroxyl groups and also mixtures thereof.

Fabric Softeners

In a further exemplary embodiment the liquid laundry detergent compositions of the present invention comprise softener component in an amount up to 15% by weight, preferably in the range from 0.1% to 10% by weight, more preferably in the range from 0.5% to 7% by weight and especially in the range from 1% to 3% by weight, each percentage being based on the entire composition.

The fabric softening agent may comprise any agent that softens and controls static electricity in fabrics. Examples of fabric-softening components are quaternary ammonium compounds, cationic polymers, and emulsifiers.

Suitable examples are quaternary ammonium compounds of the formulae (I) and (II)

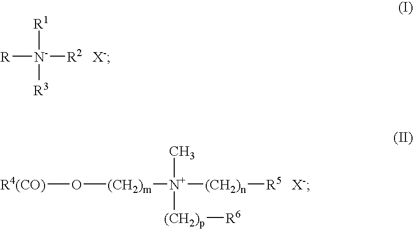

where, in (I), R and R1 each represent an acyclic alkyl radical of 12 to 24 carbon atoms, R2 represents a saturated C1-C4-alkyl or hydroxyalkyl radical, R3 is either the same as R, R1 or R2 or represents an aromatic radical. X— represents either a halide, methosulfate, methophosphate or phosphate ion and also mixtures thereof. Examples of cationic compounds of the formula (I) are didecyldimethylammonium chloride, ditallowdimethylammonium chloride or dihexadecylammonium chloride.

Compounds of the formula (II) are known as ester quats. Ester quats are notable for excellent biodegradability. In the formula (II), R4 represents an aliphatic alkyl radical of 12 to 22 carbon atoms which has 0, 1, 2 or 3 double bonds; R5 represents H, OH or O(CO)R7, R6 represents H, OH or O(CO)R8 independently of R5, with R7 and R8 each being independently an aliphatic alkyl radical of 12 to 22 carbon atoms which has 0, 1, 2 or 3 double bonds. m, n and p are each independently 1, 2 or 3. X— may be either a halide, methosulfate, methophosphate or phosphate ion and also mixtures thereof. Preference is given to compounds where R5 is O(CO)R7 and R4 and R7 are alkyl radicals having 16 to 18 carbon atoms. Particular preference is given to compounds wherein R6 also represents OH. Examples of compounds of the formula (II) are methyl-N-(2-hydroxyethyl)-N,N-di-(tallowacyloxyethyl)ammonium methosulfate, bis-(palmitoyl)ethylhydroxyethylmethylammonium methosulfate or methyl-N,N-bis(acyloxyethyl)-N-(2-hydroxyethyl)ammonium methosulfate. In quaternized compounds of the formula (II) which comprise unsaturated alkyl chains, preference is given to acyl groups whose corresponding fatty acids have an iodine number between 5 and 80, preferably between 10 and 60 and especially between 15 and 45 and also a cis/trans isomer ratio (in % by weight) of greater than 30:70, preferably greater than 50:50 and especially greater than 70:30. Commercially available examples are the methylhydroxyalkyldialkoyloxyalkylammonium methosulfates marketed by Stepan under the Stepantex® brand or the Cognis products appearing under Dehyquart® or the Goldschmidt-Witco products appearing under Rewoquat®. Preferred compounds further include the diester quats of the formula (III) which are obtainable under the name Rewoquat® W 222 LM or CR 3099 and provide stability and color protection as well as softness.

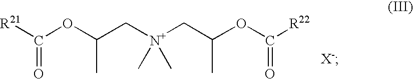

where R21 and R22 each independently represent an aliphatic radical of 12 to 22 carbon atoms which has 0, 1, 2 or 3 double bonds.

As well as the quaternary compounds described above it is also possible to use other known compounds, for example quaternary imidazolinium compounds of the formula (IV)

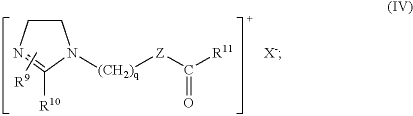

where R9 represents H or a saturated alkyl radical having 1 to 4 carbon atoms, R10 and R11 are each independently an aliphatic, saturated or unsaturated alkyl radical having 12 to 18 carbon atoms, R10 may alternatively also represent O(CO)R20, R20 being an aliphatic, saturated or unsaturated alkyl radical of 12 to 18 carbon atoms, Z is an NH group or oxygen, X— is an anion and q can assume integral values between 1 and 4.

Useful quaternary compounds are further described by the formula (V)

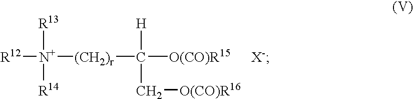

where R¹², R¹³ and R¹⁴ independently represent a C₁₋₄-alkyl, alkenyl or hydroxyalkyl group, R¹⁵ and R¹⁶ each independently represent a C₈₋₂₈-alkyl group and r is a number between 0 and 5.

As well as compounds of the formulae (I) and (II) it is also possible to use short-chain, water-soluble quaternary ammonium compounds, such as trihydroxyethylmethylammonium methosulfate or alkyltrimethylammonium chlorides, dialkyldimethylammonium chlorides and trialkylmethylammonium chlorides, for example cetyltrimethylammonium chloride, stearyltrimethylammonium chloride, distearyldimethylammonium chloride, lauryldimethylammonium chloride, lauryldimethylbenzylammonium chloride and tricetylmethylammonium chloride.

Similarly, protonated alkylamine compounds, which have a softening effect, and also the nonquaternized, protonated precursors of cationic emulsifiers are suitable.

Cationic compounds useful in the present invention further include quaternized protein hydrolyzates.

Suitable cationic polymers include the polyquaternium polymers, as in the CTFA Cosmetic Ingredient Dictionary (The Cosmetic, Toiletry and Fragrance, Inc. 1997), in particular the polyquaternium-6, polyquaternium-7, polyquaternium-10 polymers (Ucare Polymer IR 400; Amerchol), also referred to as merquats, polyquaternium-4 copolymers, such as graft copolymers with a cellulose backbone and quaternary ammonium groups which are bonded via allyldimethylammonium chloride, cationic cellulose derivatives, such as cationic guar, such as guar hydroxypropyltriammonium chloride, and similar quaternized guar derivatives (e.g. Cosmedia Guar, manufacturer: Cognis GmbH), cationic quaternary sugar derivatives (cationic alkyl polyglucosides), e.g. the commercial product Glucquat® 100, according to CTFA nomenclature a “Lauryl Methyl Gluceth-10 Hydroxypropyl Dimonium Chloride”, copolymers of PVP and dimethylaminomethacrylate, copolymers of vinylimidazole and vinylpyrrolidone, aminosilicone polymers and copolymers.

It is likewise possible to use polyquaternized polymers (e.g. Luviquat Care from BASF) and also cationic biopolymers based on chitin and derivatives thereof, for example the polymer obtainable under the trade name Chitosan® (manufacturer: Cognis).

Likewise suitable according to the invention are cationic silicone oils, such as, for example, the commercially available products Q2-7224 (manufacturer: Dow Corning; a stabilized trimethylsilylamodimethicone), Dow Corning 929 emulsion (comprising a hydroxyl-amino-modified silicone, which is also referred to as amodimethicone), SM-2059 (manufacturer: General Electric), SLM-55067 (manufacturer: Wacker) Abil®-Quat 3270 and 3272 (manufacturer: Goldschmidt-Rewo; diquaternary polydimethylsiloxanes, quaternium-80) and Siliconquat Rewoquat® SQ 1 (Tegopren® 6922, manufacturer: Goldschmidt-Rewo).

It is likewise possible to use compounds of the formula (VI)

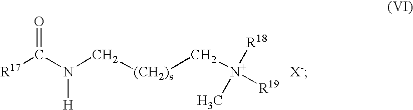

which may be alkylamidoamines in their nonquaternized or, as shown, their quaternized form. R17 may be an aliphatic alkyl radical having 12 to 22 carbon atoms with 0, 1, 2 or 3 double bonds. can assume values between 0 and 5. R18 and R19 are, independently of one another, each H, C1-4-alkyl or hydroxyalkyl. Preferred compounds are fatty acid amidoamines, such as the stearylamidopropyldimethylamine obtainable under the name Tego Amid® S18, or the 3-tallowamidopropyltrimethylammonium methosulfate obtainable under the name Stepantex® X 9124, which are characterized not only by a good conditioning effect, but also by color-transfer-inhibiting effect and in particular by their good biodegradability. Particular preference is given to alkylated quaternary ammonium compounds in which at least one alkyl chain is interrupted by an ester group and/or amido group, in particular N-methyl-N-(2-hydroxyethyl)-N,N-(ditallowacyloxyethyl)ammonium methosulfate and/or N-methyl-N-(2-hydroxyethyl)-N,N-(palmitoyloxyethyl)ammonium methosulfate.

Nonionic softeners are primarily polyoxyalkylene glycerol alkanoates, polybutylenes, long-chain fatty acids, ethoxylated fatty acid ethanolamides, alkyl polyglycosides, in particular sorbitan mono-, di- and triesters, and fatty acid esters of polycarboxylic acids.

In a preferred embodiment the liquid laundry detergent compositions of the present invention comprise cationic surfactants, preferably alkylated quaternary ammonium compounds where at least one alkyl chain is interrupted by an ester group and/or amido group.

The use of ester quats of the abovementioned formula II will be found particularly advantageous and effective. Especially ester quats of the formula
[(CH3)2N+(CH2CH2OC(O)—R)2]X—
Or
[(HOCH2CH2)(CH3)N+(CH2CH2OC(O)—R)2]X—

where R=linear saturated or unsaturated alkyl radical of 11 to 19 and preferably 13 to 17 carbon atoms. In a particularly preferred embodiment the fatty acid residues are tallow fatty acid residues. X— represents either a halide, for example chloride or bromide, methophosphate or phosphate ion, preferably from methosulfate ion, and also mixtures thereof.

Quaternary ammonium compounds of the aforementioned formula V are further preferable. Specifically, N-methyl-N-(2-hydroxyethyl)-N,N-(ditallowacyloxyethyl)ammonium methosulfate or N-methyl-N-(2-hydroxyethyl)-N,N-(dipalmitoylethyl)ammonium methosulfate are preferred.

Following is an example of the formulation of a liquid laundry detergent made in accordance with the teachings of this invention.

| Ingredient | Wt. % |
|---|---|
| Water | To balance |
| TegoSorb Conc. 50 - (Zn Ricinoleate) | 0.10% |
| EDTA (40% Active) | 0.08% |
| Linear Alkyl Sulfonate (45% Active) Anionic | 1.22% |
| AES (77% Active) Anionic | 3.60% |
| Alcohol Ethoxyolate C14-15 7EO (100% Active) | 2.50% |
| Nonionic | |
| (47% Active) Anti-redeposition Agent | 0.25% |
| Sodium Tetraborate Decahydrate (100% Active) | 0.50% |
| Sodium Chloride (100% Active) | 2.66% |
| Tinopal UNPA (10.5% Active) Whitening Agent | 0.06% |
| Perfume (100% Active) | 0.17% |
| Liquitint Blue HP (50% Active) | 0.00180% |

To demonstrate the odor neutralizing qualities of a laundry detergent containing zinc ricinoleate, a series of 4 gram swatches of cotton fabric was prepared. One-half of the swatches were washed in a laundry detergent as set forth above, that is, a laundry detergent containing zinc ricinoleate (swatches A). The remaining swatches were washed in a laundry detergent as set out above but without any zinc ricinoleate in the detergent.

Two each of Swatches A and Swatches B were placed in a glass container provided with a magnetic stirrer. One-tenth ( 1/10) of a micro liter of pyridine was placed in the jar, and the jar was sealed. The magnetic stirrer was operated for 60 minutes to insure that the pyridine vapor was evenly dispersed on all 4 swatches.

The swatches were then removed from the jar and allowed to sit for 90 minutes. At the end of the 90 minute period each set of swatches (Swatches A and Swatches B) were placed in it's own sealed glass container for a period of 1 hour at a temperature of 90° F. Thereafter, a 1 liter sample of the jar headspace was removed and trapped on a Tenax TA sorbent tube. The absorbent tubes were then analyzed for the amount of pyridine present on each tube. It was determined that the cotton swatches (Swatches A) washed in the laundry detergent containing zinc ricinoleate had about 40% less pyridine as compared to swatches that were washed in the detergent without the presence of zinc ricinoleate.

Finally, while the present invention has been described above with reference to various exemplary embodiments, many changes, combinations and modifications may be made to the exemplary embodiments without departing from the scope of the present invention. For example, the various components may be implemented in alternate ways. These alternatives can be suitably selected depending upon the particular application or in consideration of any number of factors associated with the operation of the system. In addition, the techniques described herein may be extended or modified for use with other types of devices. These and other changes or modifications are intended to be included within the scope of the present invention.

Similarly, in accordance with an aspect of another exemplary embodiment of the invention, cyclodextrin can be used effectively as a malodor neutralizing agent. Various types of cyclodextrins may be used in accordance with this aspect, including, for example, alpha-cyclodextrin, beta-cyclodextrin, gamma-cyclodextrin and/or their derivatives and/or mixtures thereof. That said, as those skilled in the art may come to appreciate, other compositions, metallic salts and the like, which exhibit the properties discussed herein, fall within the ambit of the present invention.

Thus, an aqueous laundry detergent in accordance with the present invention helps to neutralize odors that can develop on fabric such as perspiration and smoke. An additional and very important benefit is not only does the laundry product neutralize malodors it seems to neutralize only malodors and does not adversely effect fragrances that may be formulated into the laundry product.

1. A fabric cleansing composition for neutralizing malodors by absorption comprising:
a liquid detergent;
a non-ionic surfactant from about 1% to about 10% by weight of the composition;
an an-ionic surfactant from about 1% to about 15% by weight of the composition;
a metallic salt comprising zinc ricinoleate from about 0.01% to about 3% by weight of the composition; and
the composition having a pH level from about 6.5 to about 9.

2. The composition according to claim 1 wherein said an-ionic surfactant comprises at least one from the following, linear alkyl sulfonates, fatty alkylethoxy sulfates, methyl ester sulfates, fatty alcohol sulfates and sodium lauryl ether sulfates.

3. The composition according to claim 2 wherein said an-ionic surfactants comprise an amount from about 2% to about 10% by weight of the composition.

4. The composition according to claim 2 wherein said an-ionic surfactants comprise about 4% by weight of the composition.

5. The composition according to claim 1 wherein said non-ionic surfactant comprises at least one from the following, C12-C18 alcohol ethoxylates with 5-9 ethoxy groups, alcohol ethoxylated with from 14-15 carbon atoms and 7 ethoxy groups, alkyl polyglucoside, and nonyl phenol ethoxylate.

6. The composition according to claim 5 wherein said non-ionic surfactants comprise an amount from about 2% to about 4% by weight of the composition.

7. The composition according to claim 5 wherein said non-ionic surfactants comprise an amount from about 2% to about 3% by weight of the composition.

8. The composition according to claim 1 wherein said metallic salt further comprises at least one from the following, zinc chloride, zinc gluconate, zinc lactate, zinc maleate, zinc salicylate, and zinc sulfate.

9. The composition according to claim 8 wherein said metallic salt comprises an amount from about 0.02% to about 1.0% by weight of the composition.

10. The composition according to claim 8 wherein said metallic salt comprises about 0.5% by weight of the composition.

11. The composition according to claim 8 wherein said metallic salt molecules complex with one or more malodor molecules.

12. The composition according to claim 1 wherein the composition further comprises a buffering agent to adjust the pH level of the composition.

13. The composition according to claim 12 wherein said buffering agent comprises borax.

14. The composition according to claim 12 wherein said borax comprises an amount from about 0.01% to about 11% by weight of the composition.

15. The composition according to claim 12 wherein said borax comprises an amount from about 0.25% to about 1.75% by weight of the composition.

16. The composition according to claim 12 wherein said borax comprises about 0.50% by weight of the composition.

17. The composition according to claim 1 wherein the composition comprises a pH level from about 7.5 to about 7.8.

18. The composition according to claim 1 wherein the composition comprises a pH level of about 7.8.

19. The composition according to claim 1 wherein the composition further comprises a fragrance.

20. The composition according to claim 1 wherein the composition further comprises a malodor neutralizing agent.

21. The composition according to claim 20 wherein the malodor neutralizing agent comprises a cyclodextrin.

22. The composition according to claim 21 wherein said cyclodextrin comprises at least one from the following, alpha-cyclodextrin, beta-cyclodextrin, and gamma-cyclodextrin.
